(19) United States
(12) Patent Application Publication
(10) Pub. No.: US 2026/0222991 A1
(43) Pub. Date: Jul. 30, 2026

(54) LOW-POWER WAKE-UP SIGNALS FOR CONDITIONAL CONTROL CHANNEL MONITORING

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Igor GUTMAN, Hod HaSharon (IL); Tao LUO, San Diego, CA (US)

(21) Appl. No.: 19/036,858

(22) Filed: Jan. 24, 2025

(51) Int. Cl. H04W 52/02; H04W 72/231; H04W 76/28

(52) U.S. Cl. CPC H04W 52/0229; H04W 72/231; H04W 76/28

(57) ABSTRACT

Methods, systems, and devices for wireless communications are described. A user equipment (UE) may receive configuration information indicating a duration associated with conditional physical control channel monitoring and a set of one or more low-power wake-up signal (LP-WUS) monitoring occasions associated with the duration. The UE may monitor, in accordance with the set of one or more LP-WUS monitoring occasions associated with the duration, for LP-WUSs. The UE may monitor, in the duration, for a physical control channel transmission based on whether an LP-WUS was received by the UE in accordance with the monitoring for the LP-WUSs.

### FIELD OF TECHNOLOGY

The following relates to wireless communications, including low-power wake-up signals for conditional control channel monitoring.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information indicating a duration associated with conditional physical control channel monitoring and a set of one or more low-power wake-up signal (LP-WUS) monitoring occasions associated with the duration, monitoring, in accordance with the set of one or more LP-WUS monitoring occasions associated with the duration, for LP-WUSs, and monitoring, in the duration, for a physical control channel transmission based on whether a LP-WUS was received by the UE in accordance with the monitoring for the LP-WUSs.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive configuration information indicating a duration associated with conditional physical control channel monitoring and a set of one or more LP-WUS monitoring occasions associated with the duration, monitor, in accordance with the set of one or more LP-WUS monitoring occasions associated with the duration, for LP-WUSs, and monitor, in the duration, for a physical control channel transmission based on whether a LP-WUS was received by the UE in accordance with the monitoring for the LP-WUSs.

Another UE for wireless communications is described. The UE may include means for receiving configuration information indicating a duration associated with conditional physical control channel monitoring and a set of one or more LP-WUS monitoring occasions associated with the duration, means for monitoring, in accordance with the set of one or more LP-WUS monitoring occasions associated with the duration, for LP-WUSs, and means for monitoring, in the duration, for a physical control channel transmission based on whether a LP-WUS was received by the UE in accordance with the monitoring for the LP-WUSs.

A non-transitory computer-readable medium storing code for wireless communications is described. The code may include instructions executable by one or more processors (e.g., directly, indirectly, after pre-processing, without pre-processing) to receive configuration information indicating a duration associated with conditional physical control channel monitoring and a set of one or more LP-WUS monitoring occasions associated with the duration, monitor, in accordance with the set of one or more LP-WUS monitoring occasions associated with the duration, for LP-WUSs, and monitor, in the duration, for a physical control channel transmission based on whether a LP-WUS was received by the UE in accordance with the monitoring for the LP-WUSs.

In some examples of the method, UEs, and non-transitory computer-readable medium described herein, receiving the configuration information may include operations, features, means, or instructions for receiving control channel skipping trigger information that indicates the duration.

In some examples of the method, UEs, and non-transitory computer-readable medium described herein, the control channel skipping trigger information configures the UE to monitor for the LP-WUSs during the duration.

In some examples of the method, UEs, and non-transitory computer-readable medium described herein, the control channel skipping trigger information indicates the set of one or more LP-WUS monitoring occasions from a set of multiple LP-WUS monitoring occasions.

In some examples of the method, UEs, and non-transitory computer-readable medium described herein, the control channel skipping trigger information indicates a periodicity of the set of one or more LP-WUS monitoring occasions.

In some examples of the method, UEs, and non-transitory computer-readable medium described herein, monitoring for the physical control channel transmission may include operations, features, means, or instructions for monitoring for the physical control channel transmission for a second duration associated with conditional physical control channel monitoring in response to a reception of the LP-WUS.

In some examples of the method, UEs, and non-transitory computer-readable medium described herein, the second duration spans to an end of the duration associated with conditional physical control channel monitoring.

In some examples of the method, UEs, and non-transitory computer-readable medium described herein, the configuration information indicates a timer associated with the second duration.

In some examples of the method, UEs, and non-transitory computer-readable medium described herein, receiving the configuration information may include operations, features, means, or instructions for receiving search space set group switching information that configures the UE to switch to a search space set group that indicates the duration.

In some examples of the method, UEs, and non-transitory computer-readable medium described herein, monitoring for the LP-WUSs may include operations, features, means, or instructions for monitoring for the LP-WUSs in slots of the search space set group without a configured physical control channel candidate for the UE.

In some examples of the method, UEs, and non-transitory computer-readable medium described herein, the search space set group switching information configures the UE to monitor for the LP-WUSs during the duration.

In some examples of the method, UEs, and non-transitory computer-readable medium described herein, the search space set group switching information indicates the set of one or more LP-WUS monitoring occasions.

In some examples of the method, UEs, and non-transitory computer-readable medium described herein, monitoring for the LP-WUSs may include operations, features, means, or instructions for monitoring for the LP-WUSs based on a second duration of the search space set group satisfying a threshold, the second duration spanning one or more slots of the search space set group without a configured physical control channel candidate for the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports low-power wake-up signals (LP-WUSs) for conditional control channel monitoring in accordance with one or more aspects of the present disclosure.

FIG. 2 shows an example of a wireless communications system that supports LP-WUSs for conditional control channel monitoring in accordance with one or more aspects of the present disclosure.

FIG. 3 shows an example of a search space set group (SSSG) switching configuration that supports LP-WUSs for conditional control channel monitoring in accordance with one or more aspects of the present disclosure.

FIG. 4 shows an example of a process flow that supports LP-WUSs for conditional control channel monitoring in accordance with one or more aspects of the present disclosure.

FIGS. 5 and 6 show block diagrams of devices that support LP-WUSs for conditional control channel monitoring in accordance with one or more aspects of the present disclosure.

FIG. 7 shows a block diagram of a communications manager that supports LP-WUSs for conditional control channel monitoring in accordance with one or more aspects of the present disclosure.

FIG. 8 shows a diagram of a system including a device that supports LP-WUSs for conditional control channel monitoring in accordance with one or more aspects of the present disclosure.

FIGS. 9 through 11 show flowcharts illustrating methods that support LP-WUSs for conditional control channel monitoring in accordance with one or more aspects of the present disclosure.

### DETAILED DESCRIPTION

A wireless communications system may support techniques to reduce power consumption at a user equipment (UE). For example, a network entity may configure a UE to skip physical downlink control channel (PDCCH) monitoring occasions for an indicated duration, reducing power consumption at the UE associated with monitoring for PDCCH signaling. In some cases, a network entity may configure a UE to switch to using a search space set group (SSSG) that includes fewer PDCCH candidates configured for the UE, which also may reduce power consumed at the UE to monitor for PDCCH signaling. In some cases, an SSSG may include a duration (e.g., a time window) without any PDCCH candidates configured for the UE. In some techniques, if a UE is configured to perform PDCCH skipping for a duration, or the UE is configured to switch to an SSSG without configured candidate PDCCH resources for a duration, the UE may be unable to receive control signaling during those durations.

Some wireless communications system may support a low-power wake-up signal (LP-WUS). A network entity may transmit an LP-WUS to a UE to indicate a PDCCH transmission to the UE while the UE operates in a lower-power state, such as during an off duration of a connected-mode discontinuous reception (C-DRX) cycle. The UE may be equipped with a main radio, or a higher-power radio, and a low-power radio. The UE may power down the main radio when operating in the lower-power state and monitor for an LP-WUS using the low-power radio. If the UE receives an LP-WUS, the UE may provide power to the main radio and monitor for the PDCCH transmission using the main radio.

A wireless communications system described herein may support communication of an LP-WUS to a UE configured for conditional downlink control channel monitoring. For example, a UE may be configured to perform PDCCH skipping or PDCCH monitoring adaptation for a duration, or configured to switch to an SSSG with a duration that does not include PDCCH candidates configured for the UE, or both. The UE may be configured with LP-WUS monitoring occasions during the duration(s), and the UE may monitor for an LP-WUS using the low-power radio during the duration(s). If the UE detects an LP-WUS during the duration(s), the UE may resume PDCCH monitoring. For example, the UE may cancel the PDCCH skipping, such as for a duration of a timer or for a remainder of the PDCCH skipping duration. If the UE is configured to switch to an SSSG without configured PDCCH candidates, the UE may monitor for an LP-WUS in slots without configured PDCCH candidate resources. The UE may monitor for PDCCH signaling while being configured with the SSSG without configured PDCCH candidate resources after detecting the LP-WUS.

In some examples, downlink control information that configures the conditional downlink control channel monitoring may indicate for a UE to monitor for LP-WUS. For example, downlink control information that configures a UE for PDCCH skipping may indicate for the UE to monitor for LP-WUS in LP-WUS monitoring occasions within a duration associated with PDCCH skipping. Additionally, or alternatively, downlink control information that configures a UE to switch from a first SSSG to a second SSSG may indicate for the UE to monitor for LP-WUS in LP-WUS monitoring occasions while the UE is configured with the second SSSG. These techniques may enable a UE to receive downlink control signaling while the UE is configured for power-saving techniques (e.g., PDCCH skipping or SSSG switching) by using LP-WUS signaling.

Aspects of the disclosure are initially described in the context of wireless communications systems. Aspects of the disclosure are further illustrated by and described with reference to an SSSG switching configuration, a process flow, apparatus diagrams, system diagrams, and flowcharts that relate to LP-WUSs for conditional control channel monitoring.

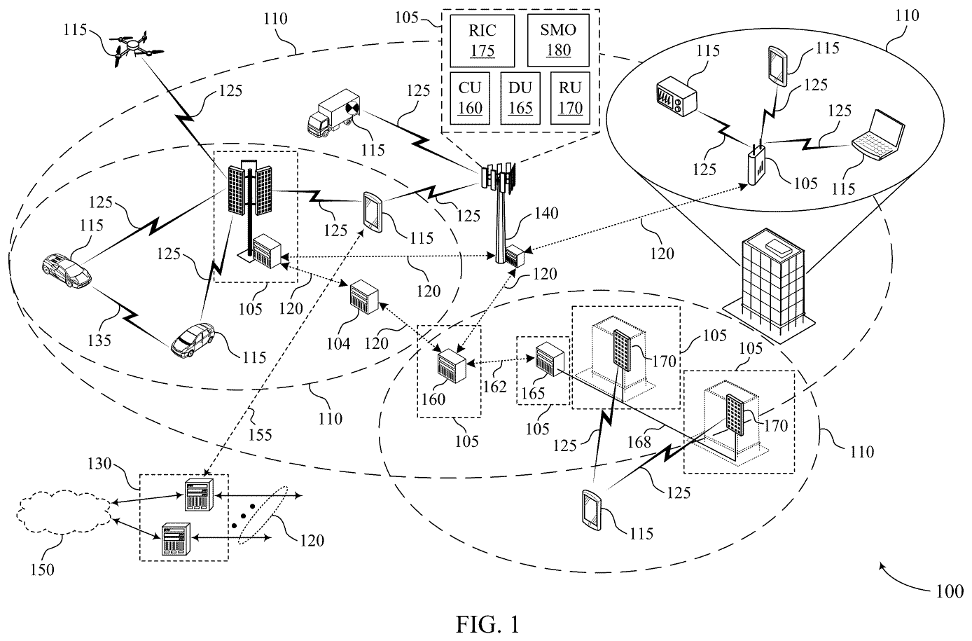

FIG. 1 shows an example of a wireless communications system 100 that supports LP-WUSs for conditional control channel monitoring in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support LP-WUSs for conditional control channel monitoring as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may implement techniques to reduce power consumption at a UE 115, a network entity 105, or both. For example, a UE 115 may operate in accordance with a C-DRX cycle while in an RRC connected mode. The C-DRX cycle may include an on duration and an off duration. The UE 115 may operate in accordance with a lower-power state during the off duration and a higher-power state during the on duration. In some examples, the UE 115 may turn off a main radio equipped to the UE 115 during the off duration to reduce power consumption, and the UE 115 may turn on the main radio during the on duration to monitor for control signaling. For example, the UE 115, if the UE is not in an active time of the C-DRX cycle (e.g., the on duration), the UE 115 may may enter a deep sleep mode, such as during the off duration of the C-DRX cycle.

The wireless communications system 100 may support communication of an LP-WUS. A network entity 105 may transmit an LP-WUS to a UE 115 to trigger the UE 115 to monitor for PDCCH signaling. For example, the UE 115 may be equipped with a main radio (e.g., used for uplink and downlink control and data signaling) and a low-power radio (e.g., a low-power receiver). The UE 115 may use the low-power radio for reception of low-power signaling, such as LP-WUSs or low-power synchronization signals. With the main radio turned off (e.g., during an off duration of the C-DRX cycle), the UE 115 may use the low-power radio to monitor for LP-WUSs. If the network entity 105 transmits an LP-WUS, the UE 115 may wake up (e.g., switch on) the main radio of the UE 115 and receive a control message from the network entity 105 using the main radio. For example, the LP-WUS may trigger the UE 115 to monitor for PDCCH signaling.

In some examples, a UE 115 may be configured with LP-WUS monitoring occasions, during which the UE 115 may monitor for an LP-WUS. In some examples, the LP-WUS monitoring occasions may be configured during the off duration of the C-DRX cycle. The network entity 105 may transmit higher layer signaling, such as RRC signaling, to configure the UE 115 with the LP-WUS monitoring occasions.

A UE 115 may be able to quickly turn on and off a low-power radio. In some examples, a UE 115 may use a low-power radio to receive and process simple signals, such as signals transmitted using limited bandwidth and having a simple waveform. For example, an LP-WUS may have an on-off keying (OOK) waveform. A low-power radio may use significantly less power to operate than a main radio. In some examples, a UE 115 may use a low-power radio for monitoring but not transmission.

In some examples, the wireless communications system 100 may support additional techniques for power savings at a UE 115, such as conditional downlink control channel monitoring. Conditional downlink control channel monitoring may refer to PDCCH skipping, SSSG switching, or a combination thereof. Conditional downlink control channel monitoring techniques may reduce power consumption at a UE 115 by reducing or preventing PDCCH monitoring or PDCCH searching, or both, at the UE 115.

For example, the wireless communications system 100 may support configuring a UE 115 to perform PDCCH skipping. Monitoring and searching for PDCCH signaling may consume significant power at a UE 115. By skipping searching a PDCCH, the UE 115 may save power or reduce power consumption. For example, a network entity 105 may transmit downlink control information to the UE 115 indicating a PDCCH skipping duration. The UE 115 may not monitor for or search for PDCCH signaling during the indicated PDCCH skipping duration.

In some examples, a duration for PDCCH skipping may correspond to a quantity of slots. For example, a network entity 105 may indicate for a UE 115 to skip monitoring for PDCCH in a next N slots, and the UE 115 may skip monitoring for PDCCH during the next N slots. In some examples, the duration for the PDCCH skipping may start from a first slot after the UE 115 receives the PDCCH skipping indication. A UE 115 may be provided with (e.g., configured with) one or more

skipping durations, during which the UE 115 does not monitor for or search for PDCCH signaling. For example, a network entity 105 may transmit higher layer signaling (e.g., RRC signaling) configuring one or more PDCCH skipping durations. A parameter such as “pdcch-SkippingDurationList” in RRC signaling may be used to configure the one or more PDCCH skipping durations. A network entity 105 may transmit downlink control information that configures the UE 115 to perform PDCCH skipping for one of the configured PDCCH skipping durations. A network entity 105 may transmit downlink control information with Format 0_1, Format 0_2, Format 1_1, or Format 1_2 to configure a UE 115 to perform PDCCH skipping.

In some examples, the wireless communications system 100 may support SSSG switching to improve UE power savings. A UE 115 may be provided (e.g., configured with) multiple SSSG indexes. Each search space set may be configured with a different amount of searching for the UE 115. For example, a first search space set may be a large search space set and include a large quantity of candidate PDCCH resources for the UE 115 to search for PDCCH signaling. A second search space set may be a smaller search space set and include fewer candidate PDCCH resources for the UE 115 to search for PDCCH signaling. In some examples, a search space set may not include any candidate PDCCH resources for the UE 115, such as for a duration or at all. For example, the search space set may be an empty search space set.

With SSSG switching, power consumption may be reduced at the UE 115 by switching the UE 115 from a large search space set to a smaller or empty search space set. When the UE 115 is configured to switch to the smaller search space set, the UE 115 may have fewer candidate PDCCH resources to search for PDCCH signaling. A network entity 105 may transmit downlink control information to a UE 115 to configure the UE 115 to switch search space sets (e.g., perform SSSG switching). The network entity 105 may transmit downlink control information with Format 0_1, Format 0_2, Format 1_1, or Format 1_2 to configure the UE 115 to configure the UE 115 to switch SSSGs.

The wireless communications system 100 may support using an LP-WUS with conditional downlink control channel monitoring techniques, such as PDCCH skipping or SSG switching. During slots in which a UE 115 does not monitor for PDCCH, the UE 115 may monitor for an LP-WUS.

For example, a UE 115 may be configured to perform PDCCH skipping for a duration (e.g., a PDCCH skipping duration), and the UE 115 may monitor for LP-WUSs in LP-WUS monitoring occasions within the duration. If the UE 115 detects an LP-WUS in the PDCCH skipping duration, the UE 115 may resume PDCCH monitoring (e.g., cancel the PDCCH skipping). In some examples, the UE 115 may monitor for PDCCH for a duration of a timer, or the UE 115 may resume PDCCH monitoring for a remainder of the PDCCH skipping duration.

If a UE 115 is configured to switch to an SSSG with fewer candidate PDCCH resources or a duration without any candidate PDCCH resources, the UE 115 may monitor for LP-WUSs in LP-WUS monitoring occasions. For example, the UE 115 may be configured to switch to an SSSG that includes a duration without candidate PDCCH resources. The UE 115 may monitor for LP-WUSs in LP-WUS monitoring occasions in the duration without candidate PDCCH resources. If the UE 115 detects an LP-WUS in the duration without candidate PDCCH resources, the UE 115 may monitor for downlink control channel signaling.

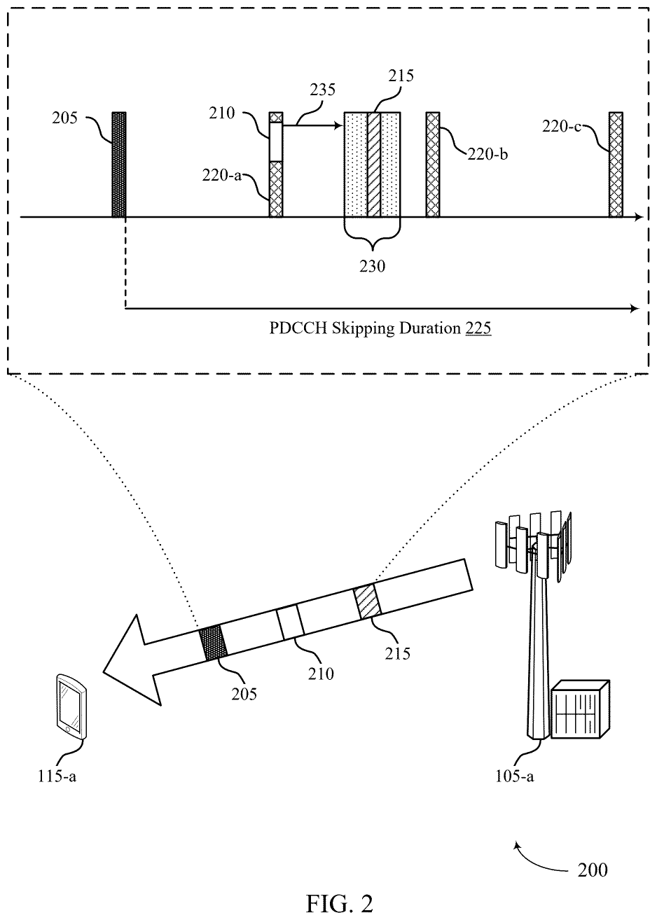

FIG. 2 shows an example of a wireless communications system 200 that supports LP-WUSs for conditional control channel monitoring in accordance with one or more aspects of the present disclosure. The wireless communications system 200 may implement aspects of a wireless communications system 100. For example, the wireless communications system 200 may include a UE 115-a and a network entity 105-a.

The wireless communications system 200 may support LP-WUS techniques and conditional control channel monitoring techniques. The network entity 105-a may transmit configuration information 205 to the UE 115-a. The configuration information 205 may configure the UE 115-a for LP-WUS monitoring, PDCCH skipping, SSSG switching, or any combination thereof. For example, the configuration information 205 may configure the UE 115-a with one or more LP-WUS monitoring occasions 220, during which the UE 115-a may monitor for an LP-WUS 210. In some examples, the configuration information 205 may configure the UE 115-a with one or more PDCCH skipping configurations (e.g., PDCCH skipping durations 225, which may be repeated in accordance with a periodicity or repetition interval). In some examples, the configuration information 205 may configure the UE 115-a with one or more search space sets or SSSGs. In some examples, the configuration information 205 may configure the UE 115-a with parameters for a C-DRX cycle or to operate in accordance with to the C-DRX cycle.

In some examples, the configuration information 205 may include higher layer signaling, such as RRC signaling, lower layer signaling, such as downlink control information, or both. For example, the configuration information 205 may include RRC signaling that configures the UE 115-a with an LP-WUS configuration, PDCCH monitoring configuration, a PDCCH skipping configuration, one or more search space set configurations, or any combination thereof. Additionally, or alternatively, the configuration information 205 may include downlink control information which indicates parameters associated with PDCCH skipping, the LP-WUS configuration, SSSG switching, or any combination thereof, or triggers the UE 115-a for PDCCH skipping, SSSG switching, or both.

Additionally, or alternatively, network entity 105-a may transmit downlink control information to the UE 115-a. In some examples, the downlink control information may configure the UE 115-a with a conditional downlink control channel monitoring configuration. For example, the downlink control information may configure the UE 115-a to perform PDCCH skipping. The downlink control information may indicate a PDCCH skipping duration 225. During the PDCCH skipping duration 225, the UE 115-a may be configured to conditionally monitor (e.g., not monitor unless otherwise notified by an LP-WUS 210) for or search for PDCCH signaling. The PDCCH skipping duration 225 may correspond to a quantity of slots. For example, the configuration information 205 (e.g., downlink control information) may indicate for the UE 115-a to skip monitoring for PDCCH in a next N slots (e.g., corresponding to the PDCCH skipping duration 225).

In some examples, the downlink control information may indicate for the UE 115-a to monitor for an LP-WUS 210. For example, the downlink control information may indicate for the UE 115-a to monitor for LP-WUSs 210 in LP-WUS monitoring occasions 220 that are within, or overlap with, the PDCCH skipping duration 225.

For example, in slots in which the UE 115-a is not monitoring for PDCCH, the UE 115-a may monitor for an LP-WUS 210. The UE 115-a may monitor for LP-WUSs 210 in the LP-WUS monitoring occasions 220 that overlap with the PDCCH skipping duration 225. For example, the UE 115-a may monitor for an LP-WUS 210 in an LP-WUS monitoring occasion 220-a, an LP-WUS monitoring occasion 220-b, and an LP-WUS monitoring occasion 220-c.

The downlink control information that triggered PDCCH skipping may indicate whether the UE 115-a is to monitor for LP-WUSs 210. In some examples, the downlink control information may indicate LP-WUS monitoring occasions 220 the UE 115-a is to monitor. For example, the downlink control information may indicate that the UE 115-a is to monitor for LP-WUSs in the LP-WUS monitoring occasion 220-a and the LP-WUS monitoring occasion 220-b. In some examples, the downlink control information may include timing information or identifiers for the LP-WUS monitoring occasions 220 the UE 115-a is to monitor in the PDCCH skipping duration 225.

In some examples, the downlink control information may configure the UE 115-a with one or more LP-WUS monitoring occasions 220. For example, the downlink control information may indicate a periodicity of LP-WUS monitoring occasions 220, and the UE 115-a may monitor for LP-WUSs in LP-WUS monitoring occasions 220 in accordance with the LP-WUS monitoring occasion periodicity indicated by the downlink control information.

In some examples, the UE 115-a may detect a LP-WUS 210 in an LP-WUS monitoring occasion 220 that overlaps with the PDCCH skipping duration 225. For example, the UE 115-a may detect a LP-WUS 210 in the LP-WUS monitoring occasion 220-a, and may monitor for PDCCH signaling based on detecting the LP-WUS 210. In some examples, receiving the LP-WUS 210 may suspend (e.g., inhibit, supersede, cancel, trigger a temporary or situational exit from) PDCCH skipping during at least a portion of the PDCCH skipping duration 225 (e.g., the instance of PDCCH skipping duration 225 associated with the detection of the LP-WUS 210), such that PDCCH skipping may be performed at the beginning of a subsequent PDCCH skipping duration 225 (not shown) in accordance the PDCCH skipping configuration (e.g., as configured by the network entity 105-a). For example, the UE 115-a may monitor for PDCCH signaling, such as a PDCCH transmission 215, in the PDCCH skipping duration 225 based on detecting the LP-WUS 210.

The UE 115-a may monitor for the PDCCH transmission 215 in a PDCCH monitoring duration 230 (e.g., a portion of less than all the PDCCH skipping duration 225). In some examples, the PDCCH monitoring duration 230 may be offset (e.g., by a delay 235) from a transmission of or reception of the LP-WUS 210. For example, these techniques may be implemented using a low-power radio and a main radio of the UE 115-a. In some examples, the UE 115-a may turn off power to the main radio, such as in accordance with a C-DRX cycle or based on receiving the PDCCH skipping indication, and the delay 235 may correspond to a start-up time of the main radio. For example, after the UE 115-a receives the LP-WUS 210, the UE 115-a may provide power to the main radio to receive the PDCCH transmission 215 (e.g., as transmitted by the network entity 105-a in accordance with the delay 235), and the delay 235 may support the UE 115-a providing power to the main radio.

In some examples, the UE 115-a may cancel the PDCCH skipping based on detecting the LP-WUS 210. For example, the UE 115-a may cancel the PDCCH skipping configuration, and the UE 115-a may resume PDCCH monitoring for a remainder of the PDCCH skipping duration 225. In some examples, the UE 115-a may continue to continuously monitor for PDCCH signaling, for example, in accordance with configured PDCCH monitoring occasions or candidate PDCCH resources, based on detecting the LP-WUS 210.

In some examples, the UE 115-a may continue to monitor for PDCCH signaling in accordance with a timer. For example, the UE 115-a may initialize a timer after receiving the PDCCH transmission 215, and the UE 115-a may resume PDCCH monitoring within the PDCCH skipping duration 225 for a duration of the timer (e.g., while the timer is active). In some examples, the UE 115-a may continue the PDCCH skipping operation after the timer expires (e.g., in the PDCCH skipping duration 225). In some examples, the configuration information 205 may configure the UE 115-a with the timer. For example, the configuration information 205 may indicate a length of the timer. Additionally, or alternatively, the downlink control information may indicate information for the timer.

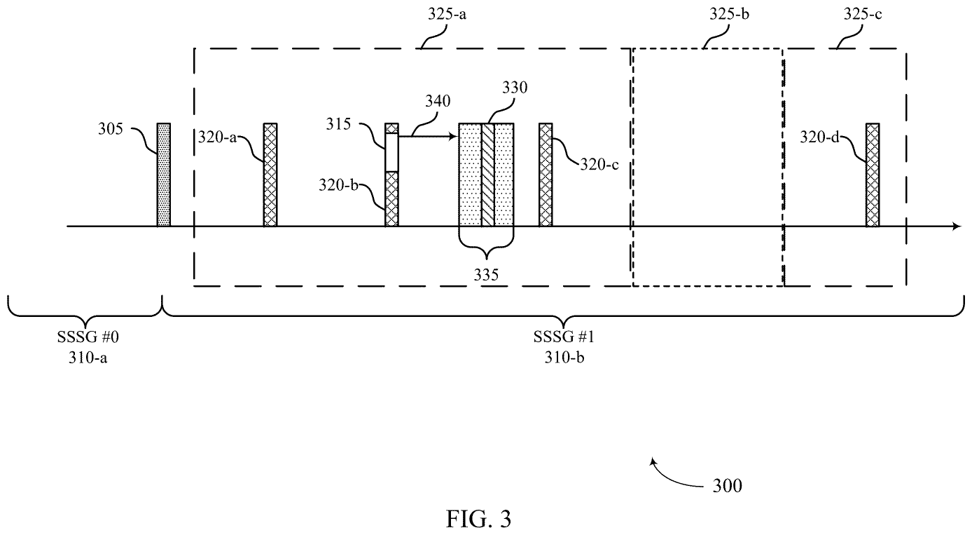

While these techniques are generally described with reference to PDCCH skipping, these techniques may additionally, or alternatively, be applied to other conditional downlink control channel monitoring techniques. For example, these techniques may be applied to SSSG switching, as described with reference to FIG. 3.

FIG. 3 shows an example of an SSSG switching configuration 300 that supports LP-WUSs for conditional control channel monitoring in accordance with one or more aspects of the present disclosure. The SSSG switching configuration 300 may implement aspects of a wireless communications system 100 and a wireless communications system 200. For example, the SSSG switching configuration 300 may be implemented by a UE 115 or a network entity 105, or both, as described herein.

The SSSG switching configuration 300 shows an example of using LP-WUS techniques with conditional control channel monitoring techniques, such as SSSG switching. A network entity 105 may transmit configuration information to a UE 115, which may configure the UE 115 for LP-WUS monitoring, PDCCH skipping, SSSG switching, or any combination thereof. For example, the configuration information may configure the UE 115 with one or more LP-WUS monitoring occasions 320, during which the UE 115 may monitor for an LP-WUS 315. In some examples, the configuration information may configure the UE 115 with parameters for a C-DRX cycle or to operate in accordance with the C-DRX cycle. The configuration information may include RRC signaling or downlink control channel signaling (such as downlink control information 305), or both.

In some examples, the configuration information may configure the UE 115 with one or more search space sets or SSSGs. For example, the configuration information may configure the UE 115 with a first search space set 310-a (SSSG #0 in FIG. 3) and a second search space set 310-b (SSSG #1 in FIG. 3). The first search space set 310-a may be an example of a relatively large search space set and may include a relatively large quantity of candidate PDCCH resources for the UE 115. The second search space set 310-b may be an example of a relatively small search space set and may include fewer candidate PDCCH resources for the UE 115 than the first search space set 310-a. For example, the second search space set 310-b may include a duration 325-a and a duration 325-c, each of which does not include any PDCCH candidate resources for the UE 115. In some examples, the second search space set 310-b may include a duration 325-b which does include PDCCH candidate resources for the UE 115. In some other examples, the second search space set 310-b may be an example of an empty search space set which does not include any candidate PDCCH resources for the UE 115.

The network entity 105 may transmit downlink control information 305 to the UE 115. In some examples, the downlink control information 305 may configure the UE 115 with a conditional downlink control channel monitoring configuration. For example, the downlink control information 305 may configure the UE 115 to switch from the first search space set 310-a to the second search space set 310-b.

In some examples, the downlink control information 305 may indicate for the UE 115 to monitor for an LP-WUS 315. For example, the downlink control information 305 may indicate for the UE 115 to monitor for LP-WUSs 315 in LP-WUS monitoring occasions 320. In some examples, the UE 115 may monitor for LP-WUSs 315 in time resources (e.g., slots) in which the UE 115 does not have a candidate PDCCH resource.

In some examples, the downlink control information 305 may indicate, or specify, LP-WUS monitoring occasions 320 during which the UE 115 is to monitor. For example, the configuration information may configure the UE 115 with one or more sets of LP-WUS monitoring occasions, and the downlink control information 305 may identify a set of LP-WUS monitoring occasions. The UE 115 may monitor for LP-WUSs 315 in the identified set of LP-WUS monitoring occasions 320. For example, the downlink control information 305 may indicate an LP-WUS monitoring occasion 320-a, an LP-WUS monitoring occasion 320-b, an LP-WUS monitoring occasion 320-c, and an LP-WUS monitoring occasion 320-d, and the UE 115 may monitor for LP-WUSs 315 in the indicated LP-WUS monitoring occasions. Additionally, or alternatively, the LP-WUS monitoring occasion 320-a, the LP-WUS monitoring occasion 320-b, the LP-WUS monitoring occasion 320-c, and the LP-WUS monitoring occasion 320-d may each correspond to an LP-WUS monitoring occasion set, and the downlink control information 305 may indicate the LP-WUS monitoring occasion set.

In some examples, the second search space set 310-b may include durations (e.g., time windows) that do not include any resources for the UE 115 to receive PDCCH signaling. For example, the duration 325-a and the duration 325-b may each not include resources for the UE 115 to receive PDCCH signaling. If a duration in a search space set 310 (e.g., in an SSSG) without a resource for the UE 115 to receive PDCCH signaling satisfies a threshold, the UE 115 may monitor for an LP-WUS 315 in that duration. For example, the duration 325-a may span longer than a threshold, and the UE 115 may monitor for an LP-WUS 315 in LP-WUS monitoring occasions 320 within the duration 325-a based on the duration 325-a satisfying the threshold. In some examples, the configuration information or the downlink control information 305, or both, may configure the UE with the threshold.

In some examples, the UE 115 may detect an LP-WUS 315 in an LP-WUS monitoring occasion 320 while operating in accordance with the second search space set 310-b. For example, the UE 115 may detect the LP-WUS 315 in the LP-WUS monitoring occasion 320-b. The UE 115 may monitor for PDCCH signaling based on detecting the LP-WUS 315. For example, the UE 115 may monitor for PDCCH signaling, such as a PDCCH transmission 330, based on detecting the LP-WUS 315.

The UE 115 may monitor for the PDCCH transmission 330 in a PDCCH monitoring duration 335. In some examples, the PDCCH monitoring duration 335 may be offset (e.g., by a delay 340) from a reception of the LP-WUS 315. For example, these techniques may be implemented using a low-power radio and a main radio of the UE 115. In some examples, the UE 115 may turn off power to the main radio, such as in accordance with a C-DRX cycle or based on receiving the SSSG switching indication, and the delay 340 may support a time to start-up the main radio. For example, after the UE 115 receives the LP-WUS 315, the UE 115 may provide power to the main radio to receive the PDCCH transmission 330, and the delay 340 may correspond to the UE 115 providing power to the main radio. In some examples, the UE 115 may turn off power to the main radio based on the second search space set 310-b including the duration 325-a and the duration 325-c without candidate PDCCH resources for the UE 115.

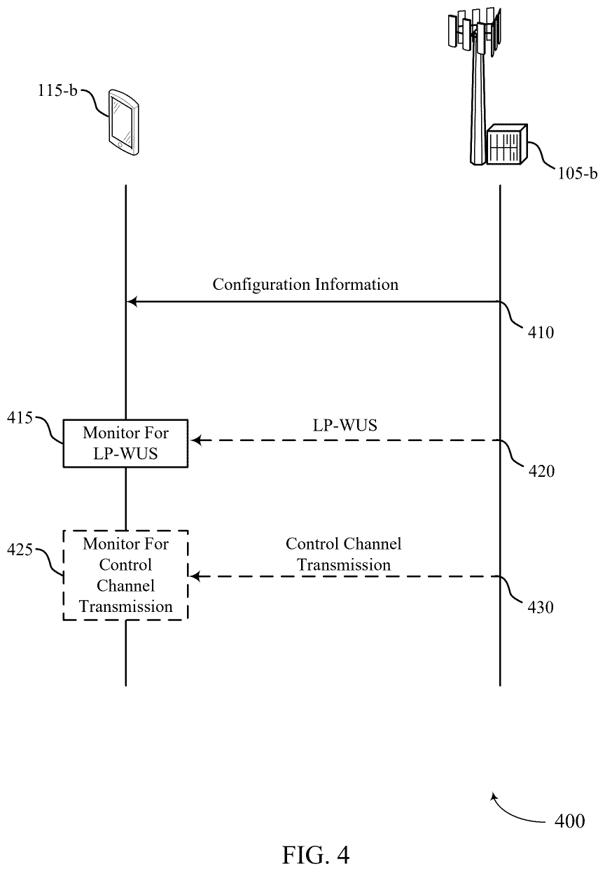

FIG. 4 shows an example of a process flow 400 that supports LP-WUSs for conditional control channel monitoring in accordance with one or more aspects of the present disclosure. The process flow 400 may implement aspects of a wireless communications system 100, a wireless communications system 200, or an SSSG switching configuration 300, or any combination thereof. For example, the process flow 400 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 400, some aspects of some operations may also be performed by one or more other wireless devices.

At 410, the network entity 105-b may transmit configuration information, which may be received by the UE 115-b. In various examples, the configuration information of 405 may include one or more indications provided in connection establishment or configuration signaling (e.g., RRC signaling), one or more indications provided in downlink control information (e.g., downlink control information of a PDCCH transmission), or a combination thereof.

In some examples, the configuration information of 410 may include one or more indications of a duration associated with conditional physical control channel monitoring and a set of one or more LP-WUS monitoring occasions associated with the duration. Additionally, or alternatively, the configuration information may indicate a configuration for an LP-WUS, the LP-WUS monitoring occasions, PDCCH skipping, one or more SSSGs, a C-DRX cycle, or any combination thereof.

In some examples, the configuration information of 410 (e.g., as downlink control information) may trigger the UE 115-b for conditional physical control channel monitoring. For example, the configuration information of 410 may configure the UE 115-b to perform PDCCH skipping. The UE 115-b may receive control channel skipping trigger information that indicates the duration. In some examples, the control channel skipping trigger information may configure the UE 115-b to monitor for the LP-WUSs in the duration. In some examples, control channel skipping trigger information may indicate the set of one or more LP-WUS monitoring occasions from multiple LP-WUS monitoring occasions. In some examples, the control channel skipping trigger information may indicate a periodicity of the set of one or more LP-WUS monitoring occasions.

Additionally, or alternatively, the configuration information of 410 (e.g., as downlink control information) may configure the UE 115-b to switch SSSGs, such as from a first SSSG to a second SSSG. The UE 115-b may receive SSSG switching information that configures the UE 115-b to switch to an SSSG that indicates (e.g., includes) the duration. In some examples, the search space set group switching information may indicate the set of one or more LP-WUS monitoring occasions. In some examples, downlink control information of the configuration information may be transmitted based on other configuration information, such as previously-communicated RRC signaling of the configuration information.

At 415, the UE 115-b may monitor for an LP-WUS. For example, the UE 115-b may monitor for an LP-WUS in accordance with the set of one or more LP-WUS monitoring occasions associated with the duration. In some examples, the UE 115-b may monitor for the LP-WUS in slots without a configured downlink control channel resource for the UE 115-b. For example, the UE 115-b may monitor for the LP-WUS in slots of the SSSG without a configured physical control channel candidate for the UE 115-b. In some examples, the UE 115-b may monitor for the LP-WUS based on a second duration of the SSSG satisfying a threshold, the second duration spanning one or more slots of the SSSG without a configured physical control channel candidate for the UE 115-b. In some examples, the network entity 105-b may transmit the LP-WUS to the UE 115-b at 420.

At 425, the UE 115-b may monitor for a physical control channel transmission based on whether the UE 115-b received the LP-WUS. A PDCCH transmission may be an example of the physical control channel transmission. For example, the UE 115-b may monitor, in the duration, for a physical control channel transmission based on whether an LP-WUS was received by the UE 115-b in accordance with the monitoring for the LP-WUS. In some examples, the network entity 105-b may transmit the physical control channel transmission to the UE 115-b at 430.

In some examples, the UE 115-b may receive the LP-WUS based on monitoring for the LP-WUS, and the UE 115-b may monitor for the physical control channel transmission in the duration based on a receipt of the LP-WUS. For example, the UE 115-b may monitor for the physical control channel transmission for a second duration associated with conditional physical control channel monitoring in response to a reception of the LP-WUS. In some examples, the second duration may span to an end of the duration associated with conditional physical control channel monitoring. In some examples, the configuration information may indicate a timer associated with the second duration. For example, the UE 115-b may receive the physical control channel transmission and start the timer, and the UE 115-b may continue to monitor for PDCCH signaling while the timer is active. In some examples, the UE 115-b may not receive the LP-WUS, and the UE 115-b may not monitor for the physical control channel transmission in the duration based on a non-receipt of the LP-WUS.

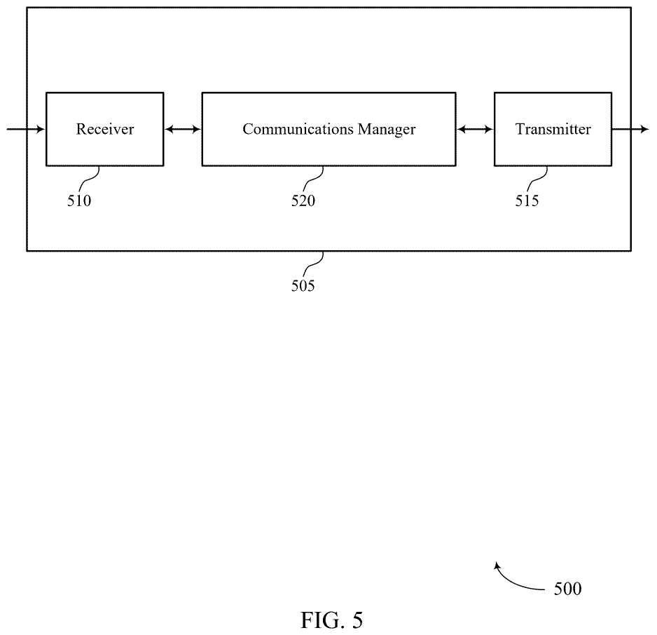

FIG. 5 shows a block diagram 500 of a device 505 that supports LP-WUSs for conditional control channel monitoring in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to LP-WUSs for conditional control channel monitoring). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to LP-WUSs for conditional control channel monitoring). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of LP-WUSs for conditional control channel monitoring as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving configuration information indicating a duration associated with conditional physical control channel monitoring and a set of one or more low-power wake-up signal monitoring occasions associated with the duration. The communications manager 520 is capable of, configured to, or operable to support a means for monitoring, in accordance with the set of one or more low-power wake-up signal monitoring occasions associated with the duration, for low-power wake-up signals. The communications manager 520 is capable of, configured to, or operable to support a means for monitoring, in the duration, for a physical control channel transmission based on whether a low-power wake-up signal was received by the UE in accordance with the monitoring for the low-power wake-up signals.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption and more efficient utilization of communication resources.

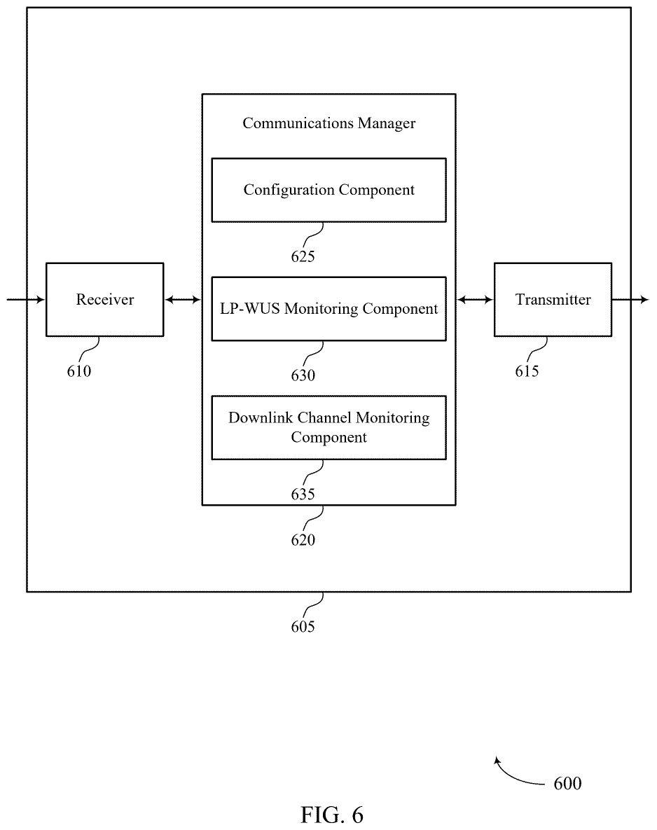

FIG. 6 shows a block diagram 600 of a device 605 that supports LP-WUSs for conditional control channel monitoring in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to LP-WUSs for conditional control channel monitoring). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to LP-WUSs for conditional control channel monitoring). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of LP-WUSs for conditional control channel monitoring as described herein. For example, the communications manager 620 may include a configuration component 625, an LP-WUS monitoring component 630, a downlink channel monitoring component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving configuration information indicating a duration associated with conditional physical control channel monitoring and a set of one or more low-power wake-up signal monitoring occasions associated with the duration. The LP-WUS monitoring component 630 is capable of, configured to, or operable to support a means for monitoring, in accordance with the set of one or more low-power wake-up signal monitoring occasions associated with the duration, for low-power wake-up signals. The downlink channel monitoring component 635 is capable of, configured to, or operable to support a means for monitoring, in the duration, for a physical control channel transmission based on whether a low-power wake-up signal was received by the UE in accordance with the monitoring for the low-power wake-up signals.

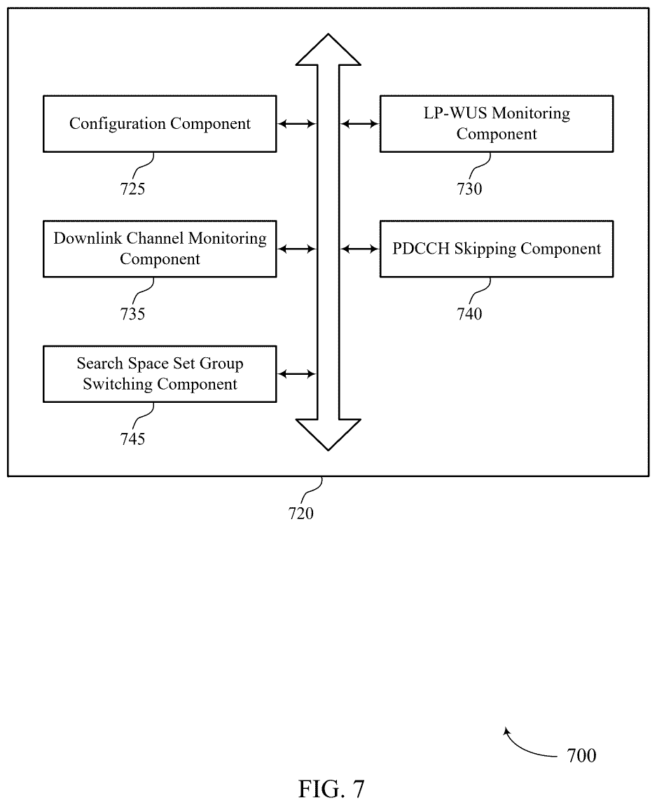

FIG. 7 shows a block diagram 700 of a communications manager 720 that supports LP-WUSs for conditional control channel monitoring in accordance with one or more aspects of the present disclosure. The communications manager 720 may be an example of aspects of a communications manager 520, a communications manager 620, or both, as described herein. The communications manager 720, or various components thereof, may be an example of means for performing various aspects of LP-WUSs for conditional control channel monitoring as described herein. For example, the communications manager 720 may include a configuration component 725, an LP-WUS monitoring component 730, a downlink channel monitoring component 735, a PDCCH skipping component 740, a search space set group switching component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving configuration information indicating a duration associated with conditional physical control channel monitoring and a set of one or more low-power wake-up signal monitoring occasions associated with the duration. The LP-WUS monitoring component 730 is capable of, configured to, or operable to support a means for monitoring, in accordance with the set of one or more low-power wake-up signal monitoring occasions associated with the duration, for low-power wake-up signals. The downlink channel monitoring component 735 is capable of, configured to, or operable to support a means for monitoring, in the duration, for a physical control channel transmission based on whether a low-power wake-up signal was received by the UE in accordance with the monitoring for the low-power wake-up signals.

In some examples, to support receiving the configuration information, the PDCCH skipping component 740 is capable of, configured to, or operable to support a means for receiving control channel skipping trigger information that indicates the duration.

In some examples, the control channel skipping trigger information configures the UE to monitor for the low-power wake-up signals within the duration.

In some examples, the control channel skipping trigger information indicates the set of one or more low-power wake-up signal monitoring occasions from a set of multiple low-power wake-up signal monitoring occasions.

In some examples, the control channel skipping trigger information indicates a periodicity of the set of one or more low-power wake-up signal monitoring occasions.

In some examples, to support monitoring for the physical control channel transmission, the downlink channel monitoring component 735 is capable of, configured to, or operable to support a means for monitoring for the physical control channel transmission for a second duration associated with conditional physical control channel monitoring in response to a reception of the low-power wake-up signal.

In some examples, the second duration spans to an end of the duration associated with conditional physical control channel monitoring.

In some examples, the configuration information indicates a timer associated with the second duration.

In some examples, to support receiving the configuration information, the search space set group switching component 745 is capable of, configured to, or operable to support a means for receiving search space set group switching information that configures the UE to switch to a search space set group that indicates the duration.

In some examples, to support monitoring for the low-power wake-up signals, the LP-WUS monitoring component 730 is capable of, configured to, or operable to support a means for monitoring for the low-power wake-up signals in slots of the search space set group without a configured physical control channel candidate for the UE.

In some examples, the search space set group switching information configures the UE to monitor for the low-power wake-up signals within the duration.

In some examples, the search space set group switching information indicates the set of one or more low-power wake-up signal monitoring occasions.

In some examples, to support monitoring for the low-power wake-up signals, the LP-WUS monitoring component 730 is capable of, configured to, or operable to support a means for monitoring for the low-power wake-up signals based on a second duration of the search space set group satisfying a threshold, the second duration spanning one or more slots of the search space set group without a configured physical control channel candidate for the UE.

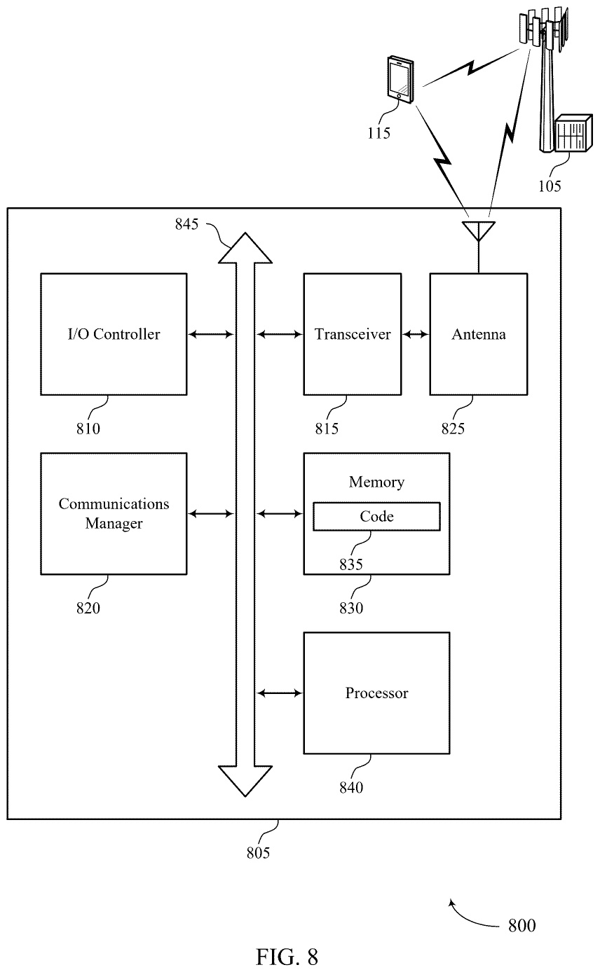

FIG. 8 shows a diagram of a system 800 including a device 805 that supports LP-WUSs for conditional control channel monitoring in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting LP-WUSs for conditional control channel monitoring). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving configuration information indicating a duration associated with conditional physical control channel monitoring and a set of one or more low-power wake-up signal monitoring occasions associated with the duration. The communications manager 820 is capable of, configured to, or operable to support a means for monitoring, in accordance with the set of one or more low-power wake-up signal monitoring occasions associated with the duration, for low-power wake-up signals. The communications manager 820 is capable of, configured to, or operable to support a means for monitoring, in the duration, for a physical control channel transmission based on whether a low-power wake-up signal was received by the UE in accordance with the monitoring for the low-power wake-up signals.

By including or configuring the communications manager 820 in accordance with examples as described herein, the device 805 may support techniques for reduced latency, reduced power consumption, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of LP-WUSs for conditional control channel monitoring as described herein, or the at least one processor 840 and the at least one memory 830 may be otherwise configured to, individually or collectively, perform or support such operations.

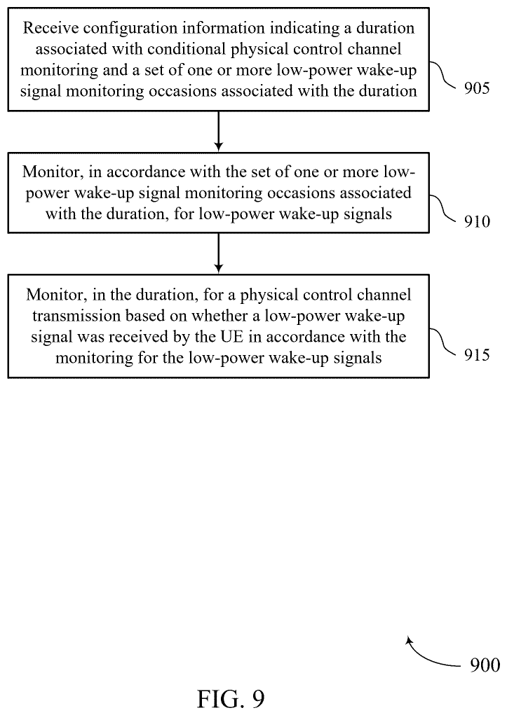

FIG. 9 shows a flowchart illustrating a method 900 that supports LP-WUSs for conditional control channel monitoring in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving configuration information indicating a duration associated with conditional physical control channel monitoring and a set of one or more low-power wake-up signal monitoring occasions associated with the duration. The operations of 905 may be performed in accordance with examples as disclosed herein. In some examples, aspects of the operations of 905 may be performed by a configuration component 725 as described with reference to FIG. 7.

At 910, the method may include monitoring, in accordance with the set of one or more low-power wake-up signal monitoring occasions associated with the duration, for low-power wake-up signals. The operations of 910 may be performed in accordance with examples as disclosed herein. In some examples, aspects of the operations of 910 may be performed by an LP-WUS monitoring component 730 as described with reference to FIG. 7.

At 915, the method may include monitoring, in the duration, for a physical control channel transmission based on whether a low-power wake-up signal was received by the UE in accordance with the monitoring for the low-power wake-up signals. The operations of 915 may be performed in accordance with examples as disclosed herein. In some examples, aspects of the operations of 915 may be performed by a downlink channel monitoring component 735 as described with reference to FIG. 7.

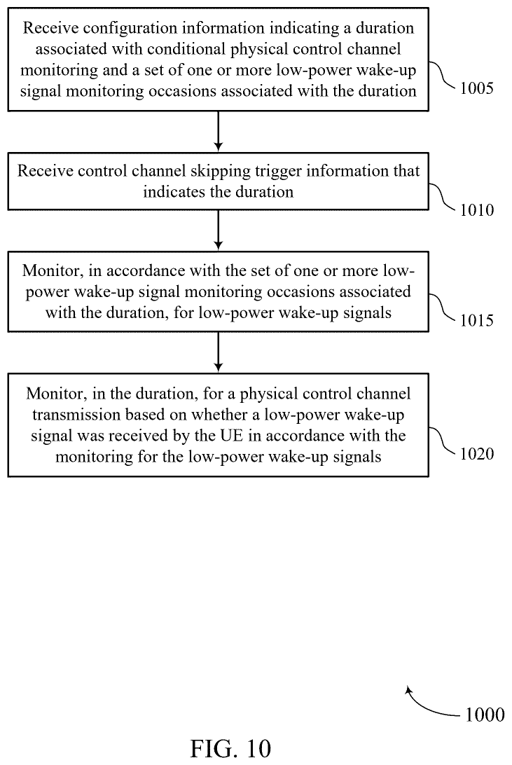

FIG. 10 shows a flowchart illustrating a method 1000 that supports LP-WUSs for conditional control channel monitoring in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving configuration information indicating a duration associated with conditional physical control channel monitoring and a set of one or more low-power wake-up signal monitoring occasions associated with the duration. The operations of 1005 may be performed in accordance with examples as disclosed herein. In some examples, aspects of the operations of 1005 may be performed by a configuration component 725 as described with reference to FIG. 7.

At 1010, the method may include receiving control channel skipping trigger information that indicates the duration. The operations of 1010 may be performed in accordance with examples as disclosed herein. In some examples, aspects of the operations of 1010 may be performed by a PDCCH skipping component 740 as described with reference to FIG. 7.

At 1015, the method may include monitoring, in accordance with the set of one or more low-power wake-up signal monitoring occasions associated with the duration, for low-power wake-up signals. The operations of 1015 may be performed in accordance with examples as disclosed herein. In some examples, aspects of the operations of 1015 may be performed by an LP-WUS monitoring component 730 as described with reference to FIG. 7.

At 1020, the method may include monitoring, in the duration, for a physical control channel transmission based on whether a low-power wake-up signal was received by the UE in accordance with the monitoring for the low-power wake-up signals. The operations of 1020 may be performed in accordance with examples as disclosed herein. In some examples, aspects of the operations of 1020 may be performed by a downlink channel monitoring component 735 as described with reference to FIG. 7.

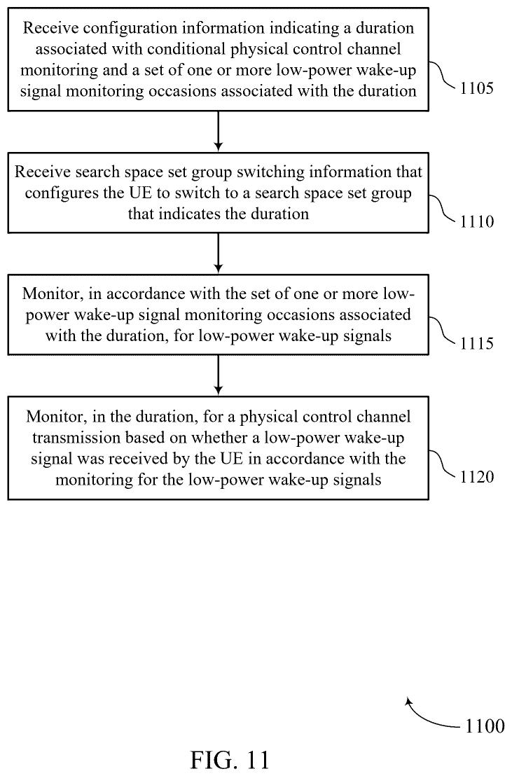

FIG. 11 shows a flowchart illustrating a method 1100 that supports LP-WUSs for conditional control channel monitoring in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving configuration information indicating a duration associated with conditional physical control channel monitoring and a set of one or more low-power wake-up signal monitoring occasions associated with the duration. The operations of 1105 may be performed in accordance with examples as disclosed herein. In some examples, aspects of the operations of 1105 may be performed by a configuration component 725 as described with reference to FIG. 7.

At 1110, the method may include receiving search space set group switching information that configures the UE to switch to a search space set group that indicates the duration. The operations of 1110 may be performed in accordance with examples as disclosed herein. In some examples, aspects of the operations of 1110 may be performed by a search space set group switching component 745 as described with reference to FIG. 7.

At 1115, the method may include monitoring, in accordance with the set of one or more low-power wake-up signal monitoring occasions associated with the duration, for low-power wake-up signals. The operations of 1115 may be performed in accordance with examples as disclosed herein. In some examples, aspects of the operations of 1115 may be performed by an LP-WUS monitoring component 730 as described with reference to FIG. 7.

At 1120, the method may include monitoring, in the duration, for a physical control channel transmission based on whether a low-power wake-up signal was received by the UE in accordance with the monitoring for the low-power wake-up signals. The operations of 1120 may be performed in accordance with examples as disclosed herein. In some examples, aspects of the operations of 1120 may be performed by a downlink channel monitoring component 735 as described with reference to FIG. 7.

The following provides an overview of aspects of the present disclosure:

Aspect 1: A method for wireless communications at a UE, comprising: receiving configuration information indicating a duration associated with conditional physical control channel monitoring and a set of one or more low-power wake-up signal monitoring occasions associated with the duration; monitoring, in accordance with the set of one or more low-power wake-up signal monitoring occasions associated with the duration, for low-power wake-up signals; and monitoring, in the duration, for a physical control channel transmission based at least in part on whether a low-power wake-up signal was received by the UE in accordance with the monitoring for the low-power wake-up signals.

Aspect 2: The method of aspect 1, wherein receiving the configuration information comprises: receiving control channel skipping trigger information that indicates the duration.

Aspect 3: The method of aspect 2, wherein the control channel skipping trigger information configures the UE to monitor for the low-power wake-up signals during the duration.

Aspect 4: The method of any of aspects 2 through 3, wherein the control channel skipping trigger information indicates the set of one or more low-power wake-up signal monitoring occasions from a plurality of low-power wake-up signal monitoring occasions.

Aspect 5: The method of any of aspects 2 through 4, wherein the control channel skipping trigger information indicates a periodicity of the set of one or more low-power wake-up signal monitoring occasions.

Aspect 6: The method of any of aspects 1 through 5, wherein monitoring for the physical control channel transmission comprises: monitoring for the physical control channel transmission for a second duration associated with conditional physical control channel monitoring in response to a reception of the low-power wake-up signal.

Aspect 7: The method of aspect 6, wherein the second duration spans to an end of the duration associated with conditional physical control channel monitoring.

Aspect 8: The method of any of aspects 6 through 7, wherein the configuration information indicates a timer associated with the second duration.

Aspect 9: The method of any of aspects 1 through 8, wherein receiving the configuration information comprises: receiving search space set group switching information that configures the UE to switch to a search space set group that indicates the duration.

Aspect 10: The method of aspect 9, wherein monitoring for the low-power wake-up signals comprises: monitoring for the low-power wake-up signals in slots of the search space set group without a configured physical control channel candidate for the UE.

Aspect 11: The method of any of aspects 9 through 10, wherein the search space set group switching information configures the UE to monitor for the low-power wake-up signals during the duration.

Aspect 12: The method of any of aspects 9 through 11, wherein the search space set group switching information indicates the set of one or more low-power wake-up signal monitoring occasions.

Aspect 13: The method of any of aspects 9 through 12, wherein monitoring for the low-power wake-up signals comprises: monitoring for the low-power wake-up signals based at least in part on a second duration of the search space set group satisfying a threshold, the second duration spanning one or more slots of the search space set group without a configured physical control channel candidate for the UE.

Aspect 14: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors (e.g., directly, indirectly, after pre-processing, without pre-processing) to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information indicating a duration associated with conditional physical control channel monitoring and a set of one or more low-power wake-up signal monitoring occasions associated with the duration;
monitor, in accordance with the set of one or more low-power wake-up signal monitoring occasions associated with the duration, for low-power wake-up signals; and
monitor, in the duration, for a physical control channel transmission based at least in part on whether a low-power wake-up signal was received by the UE in accordance with the monitoring for the low-power wake-up signals.

2. The UE of claim 1, wherein, to receive the configuration information, the one or more processors are individually or collectively operable to execute the code to cause the UE to:
receive control channel skipping trigger information that indicates the duration.

3. The UE of claim 2, wherein the control channel skipping trigger information configures the UE to monitor for the low-power wake-up signals within the duration.

4. The UE of claim 2, wherein the control channel skipping trigger information indicates the set of one or more low-power wake-up signal monitoring occasions from a plurality of low-power wake-up signal monitoring occasions.

5. The UE of claim 2, wherein the control channel skipping trigger information indicates a periodicity of the set of one or more low-power wake-up signal monitoring occasions.

6. The UE of claim 1, wherein, to monitor for the physical control channel transmission, the one or more processors are individually or collectively operable to execute the code to cause the UE to:
monitor for the physical control channel transmission for a second duration associated with conditional physical control channel monitoring in response to a reception of the low-power wake-up signal.

7. The UE of claim 6, wherein:
the second duration spans to an end of the duration associated with conditional physical control channel monitoring.

8. The UE of claim 6, wherein the configuration information indicates a timer associated with the second duration.

9. The UE of claim 1, wherein, to receive the configuration information, the one or more processors are individually or collectively operable to execute the code to cause the UE to:
receive search space set group switching information that configures the UE to switch to a search space set group that indicates the duration.

10. The UE of claim 9, wherein, to monitor for the low-power wake-up signals, the one or more processors are individually or collectively operable to execute the code to cause the UE to:
monitor for the low-power wake-up signals in slots of the search space set group without a configured physical control channel candidate for the UE.

11. The UE of claim 9, wherein the search space set group switching information configures the UE to monitor for the low-power wake-up signals within the duration.

12. The UE of claim 9, wherein the search space set group switching information indicates the set of one or more low-power wake-up signal monitoring occasions.

13. The UE of claim 9, wherein, to monitor for the low-power wake-up signals, the one or more processors are individually or collectively operable to execute the code to cause the UE to:
monitor for the low-power wake-up signals based at least in part on a second duration of the search space set group satisfying a threshold, the second duration spanning one or more slots of the search space set group without a configured physical control channel candidate for the UE.

14. A method for wireless communications at a user equipment (UE), comprising:
receiving configuration information indicating a duration associated with conditional physical control channel monitoring and a set of one or more low-power wake-up signal monitoring occasions associated with the duration;
monitoring, in accordance with the set of one or more low-power wake-up signal monitoring occasions associated with the duration, for low-power wake-up signals; and
monitoring, in the duration, for a physical control channel transmission based at least in part on whether a low-power wake-up signal was received by the UE in accordance with the monitoring for the low-power wake-up signals.

15. The method of claim 14, wherein receiving the configuration information comprises:
receiving control channel skipping trigger information that indicates the duration.

16. The method of claim 15, wherein the control channel skipping trigger information configures the UE to monitor for the low-power wake-up signals within the duration.

17. The method of claim 15, wherein the control channel skipping trigger information indicates the set of one or more low-power wake-up signal monitoring occasions from a plurality of low-power wake-up signal monitoring occasions.

18. The method of claim 15, wherein the control channel skipping trigger information indicates a periodicity of the set of one or more low-power wake-up signal monitoring occasions.

19. The method of claim 14, wherein monitoring for the physical control channel transmission comprises:
monitoring for the physical control channel transmission for a second duration associated with conditional physical control channel monitoring in response to a reception of the low-power wake-up signal.

20. A non-transitory computer-readable medium storing code for wireless communications at a user equipment (UE), the code comprising instructions executable by one or more processors to:
receive configuration information indicating a duration associated with conditional physical control channel monitoring and a set of one or more low-power wake-up signal monitoring occasions associated with the duration;
monitor, in accordance with the set of one or more low-power wake-up signal monitoring occasions associated with the duration, for low-power wake-up signals; and
monitor, in the duration, for a physical control channel transmission based at least in part on whether a low-power wake-up signal was received by the UE in accordance with the monitoring for the low-power wake-up signals.
